(19) United States
(12) Patent Application Publication
(10) Pub. No.: US 2026/0319299 A1
(43) Pub. Date: Oct. 15, 2026

(54) DISPLAY PANEL AND DISPLAY DEVICE

(71) Applicant: WUHAN CHINA STAR OPTOELECTRONICS TECHNOLOGY CO., LTD., Wuhan, Hubei (CN)

(72) Inventors: Yongdi ZHANG, Wuhan, Hubei (CN); Dewei SONG, Wuhan, Hubei (CN)

(73) Assignee: WUHAN CHINA STAR OPTOELECTRONICS TECHNOLOGY CO., LTD., Wuhan, Hubei (CN)

(21) Appl. No.: 19/152,335

(22) PCT Filed: May 9, 2025
(86) PCT No.: PCT/CN2025/094038

§ 371 Date: Jul. 30, 2025

(30) Foreign Application Priority Data
Apr. 11, 2025 (CN) 202510454704.4

(51) Int. Cl. G02F 1/1362; G02F 1/1368

(52) U.S. Cl. CPC G02F 1/136209; G02F 1/136286; G02F 1/1368

(57) ABSTRACT

A display panel and a display device are provided. The display panel includes a light-shielding layer, a first common electrode layer, a second common electrode layer, a plurality of structures, and a plurality of spacers. The light-shielding layer includes a plurality of light-shielding lines, and the light-shielding lines include a metal light-shielding layer. In a display region, the first common electrode layer is stacked with the light-shielding layer and is in contact with the metal light-shielding layer. The pad structures are disposed in the display region and on a side of the second common electrode layer away from the substrate. The spacers are disposed in the display region and disposed on the pad structures.

This application claims priority to Chinese Patent Application No. 202510454704.4, filed on Apr. 11, 2025, the entire contents which is incorporated herein by reference in its entirety.

### TECHNICAL FIELD

The present disclosure relates to display technologies, in particular to display panels and display devices.

### BACKGROUND

With the development of fifth generation (5G) mobile communication technology and advancements in virtual reality (VR) content and hardware, VR technology is experiencing a rapid growth phase. VR technology demands very high screen resolution (>1000).

For VR devices manufactured with liquid crystal display panels, due to the design characteristics of high-resolution structures, the aperture ratio of the liquid crystal display panels are lower than that of conventional products. To enhance the aperture ratio of liquid crystal display panels, light-shielding metal lines are arranged corresponding to signal lines like data lines. By doing so, the size of the organic light-shielding matrix is minimized, thus increasing the aperture ratio while decreasing the reflectivity of the light-shielding metal lines. However, the introduction of the light-shielding metal lines may cause display abnormalities in the display panel.

### SUMMARY

The embodiments of the present disclosure provide a display panel and a display device to reduce the risk of display abnormalities caused by the light-shielding layer in the display panel.

In a first aspect, embodiments of the present disclosure provide a display panel, which includes a substrate, a driving circuit layer, a light-shielding layer, a first common electrode layer, a pixel electrode layer, a second common electrode layer, a plurality of pad structures, and a plurality of spacers. The driving circuit layer is disposed on a substrate and includes a plurality of signal lines in the display region. The light-shielding layer is disposed on a side of the driving circuit layer away from the substrate and includes a plurality of light-shielding lines. The light-shielding lines overlap with at least ones of the signal lines and includes a metal light-shielding layer disposed in the display region. The first common electrode layer is stacked with the light-shielding layer in the display region and is in direct contact with the metal light-shielding layer. At least a part of the pixel electrode layer is disposed on a side of the first common electrode layer away from the substrate and on a side of the light-shielding layer away from the substrate, and is electrically insulated from the first common electrode layer. The second common electrode layer is disposed on a side of the pixel electrode layer away from the substrate and is electrically insulated from the pixel electrode layer. The pad structures are disposed in the display region and disposed on a side of the second common electrode layer away from the substrate. The spacers are disposed in the display region and disposed on the pad structures.

In a second aspect, the embodiments of the present disclosure further provide a display device, the display device includes the display panel.

### BRIEF DESCRIPTION OF THE DRAWINGS

FIG. 1 is a schematic view of a cross-sectional structure of a display panel according to some embodiments of the present disclosure.

FIG. 2 is a schematic view of the partial planar layout of a signal line and a light-shielding line according to some embodiments of the present disclosure.

FIG. 3 is a schematic cross-sectional view of the direct contact between a first common electrode layer and a light-shielding layer according to some embodiments of the present disclosure.

FIG. 4 is a schematic view of the local layout of an organic insulation layer, a light-shielding layer, a first common electrode layer, and a second passivation layer according to some embodiments of the present disclosure.

FIG. 5 is a schematic view of the partial layout of a pixel electrode layer according to some embodiments of the present disclosure.

FIG. 6 is a schematic view of a structure of a display device according to some embodiments of the present disclosure.

### LIST OF REFERENCE NUMBERS

200, display device; 300, backlight module;
100, display panel; 100A, display region; 100B, non-display region;
110, array substrate;
111, substrate;
120, driving circuit layer;
121, signal line; 1211, data line;
122, pixel driving circuit; 1221, metal oxide transistor; 1222, top gate; 1223, bottom gate;
123, gate driving circuit; 1231, low temperature polysilicon transistor; 1232, gate;
1241, first semiconductor layer; 1242, second semiconductor layer;
1251, first conductive layer; 1252, second conductive layer; 1253, third conductive layer;

1261, first gate insulation layer; 1262, second gate insulation layer; 1263, third gate insulation layer;
1271. first interlayer dielectric layer; 1272, second interlayer dielectric layer; 1273, third interlayer dielectric layer;
130, light-shielding layer; 131, light-shielding line; 132, metal light-shielding layer; 133, insulating dielectric layer; 131A, first side surface; 131B, first top surface; 131C, first bottom surface;
140, first common electrode layer; 141, first common electrode line;
150, pixel electrode layer; 151, first light-transmitting conductive layer; 152, second light-transmitting conductive layer; 153, first pixel electrode; 154, second pixel electrode;
160, organic insulation layer; 161, through groove; 162, through hole;
170, first passivation layer; 171, second passivation layer; 172, third passivation layer;
180, light-transmitting conductive structure; 181, signal transmission structure; 182, filling material;
191, pad structure; 191A, second bottom surface; 191B, second top surface; 191C, second side surface; 192, spacer;
193, second common electrode layer;
20, counter substrate;
21, organic light-shielding matrix;
H1, first connection hole; H2, second connection hole; H3, third connection hole; H4, fourth connection hole.

### DETAILED DESCRIPTION

With reference to the drawings provided in the embodiments of the present disclosure, a clear and comprehensive description of the technical solutions in these embodiments is provided in the following. Obviously, the described embodiments are only a part of embodiments of the present disclosure, and not all the embodiments. Based on the embodiments in the present disclosure, all other embodiments obtained by a person skilled in the art without any inventive effort are within the scope of the present disclosure.

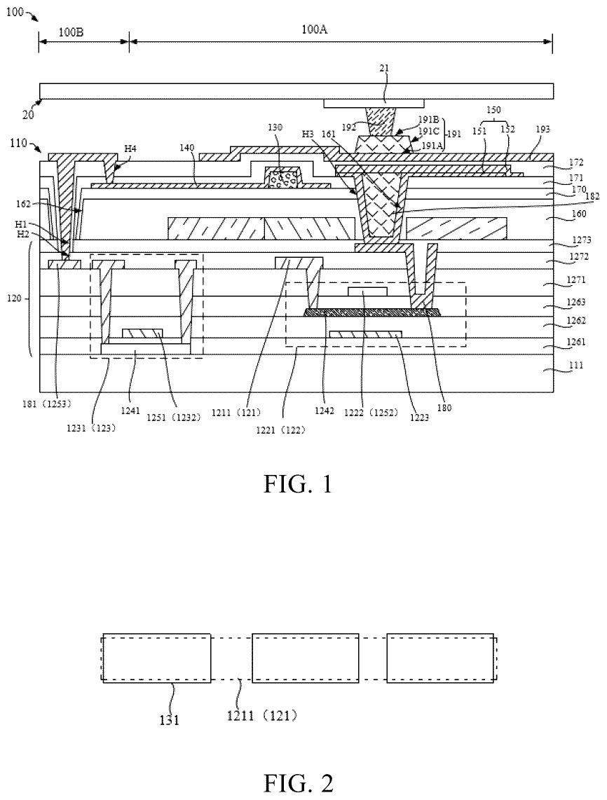

FIG. 1 is a schematic view of a cross-sectional structure of a display panel according to some embodiments of the present disclosure. FIG. 2 is a schematic view of the partial planar layout of signal lines and light-shielding lines according to some embodiments of the present disclosure.

As shown in FIG. 1, the display panel 100 includes a display region 100A and a non-display region 100B. The non-display region 100B is disposed on the periphery of the display region 100A. The display panel 100 includes an array substrate 110, a counter substrate 20, and a liquid crystal layer (not shown in the figures). The liquid crystal layer 13 is disposed between the array substrate 110 and the counter substrate 20.

The array substrate 110 includes a substrate 111, a driving circuit layer 120, a light-shielding layer 130, and first common electrode layer 140.

As shown in FIGS. 1 and 2, the driving circuit layer 120 is disposed on the substrate 111 and includes a plurality of signal lines 121 in the display region 100A. The signal lines 121 may include a plurality of data lines 1211 and a plurality of scan lines (not shown in the figures). The plurality of data lines 1211 are insulated from and intersect with the plurality of scan lines.

As shown in FIG. 1, the driving circuit layer 120 further includes a plurality of pixel driving circuits 122, which may be disposed in the display region 100A. In some embodiments, as shown in FIG. 1, the pixel driving circuit 122 may include a metal oxide transistor 1221, which is disposed in the display region 100A. Since the metal oxide active layer of the metal oxide transistor 1221 is transparent, it may enhance the aperture ratio of the display panel 100.

In addition to the metal oxide active layer, the metal oxide transistor 1221 may further include one or two gates, and one or two gates overlap with the metal oxide active layer. In some embodiments, as shown in FIG. 1, the metal oxide transistor 1221 includes a top gate 1222 and a bottom gate 1223, and the metal oxide active layer is disposed between the top gate 1222 and the bottom gate 1223. The top gate 1222 is connected to the bottom gate 1223. In this way, the on-state current of the metal oxide transistor 1221 is increased, and the off-state leakage current thereof is reduced.

in some embodiments, the pixel driving circuit 122 may further include a low-temperature polysilicon transistor. The low-temperature polycrystalline silicon transistor may be disposed in the display region 100A. Since the low-temperature polysilicon transistor possesses high mobility, it enables faster switching speeds and greater driving capability, facilitating the display panel 100 to achieve a high refresh rate.

As shown in FIG. 1, the driving circuit layer 120 may further include a plurality of gate driving circuit 123, and the gate driving circuits 123 may be disposed in the non-display region 100B. In some embodiments, the gate driving circuit 123 may include a low-temperature polysilicon transistor 1231, which is disposed in the non-display region 100B. Since the low-temperature polysilicon transistor possesses high mobility, it enables faster switching speeds and greater driving capability, facilitating the display panel 100 to achieve a high refresh rate.

In some embodiments, as shown in FIG. 1, the low-temperature polysilicon transistor 1231 includes a low-temperature polysilicon active layer and a gate 1232.

In some other embodiments, the gate driving circuit 123 may include a metal oxide transistor.

It should be noted that in the case where the pixel driving circuit 122 includes a metal oxide transistor 1221 and a gate driving circuit 123 includes a low-temperature polysilicon transistor 1231, the display panel 100 uses low-temperature polycrystalline oxide (LTPO). This enables the display panel 100 to capitalize on the strengths of the metal oxide transistor 1221 and the low-temperature polycrystalline silicon transistor 1231, thereby improving its display performance and energy efficiency.

In some embodiments, as shown in FIG. 1, the driving circuit layer 120 includes a first semiconductor layer 1241, a second semiconductor layer 1242, a first conductive layer 1251, a second conductive layer 1252 and a third conductive layer 1253.

The first semiconductor layer 1241 may include the low-temperature polysilicon active layer of the low-temperature polysilicon transistor 1231.

The second semiconductor layer 1242 is disposed on a side of the first semiconductor layer 1241 away from the substrate 111. The second semiconductor layer 1242 may include the metal oxide active layer of the metal oxide transistor 1221.

The first conductive layer 1251 may be disposed between the first semiconductor layer 1241 and the second semiconductor layer 1242. The first conductive layer 1251 may include the gate 1232 of the low-temperature polysilicon transistor 1231. The first conductive layer 1251 may further include the bottom gate 1223 of the metal oxide transistor 1221. A first gate insulation layer 1261 may be disposed between the first conductive layer 1251 and the first semiconductor layer 1241. A second gate insulation layer 1262 may be disposed between the first conductive layer 1251 and the second semiconductor layer 1242.

The second conductive layer 1252 is disposed on a side of the second semiconductor layer 1242 away from the substrate 111. As shown in FIG. 1, the second conductive layer 1252 may include the top gate 1222 of the metal oxide transistor 1221. A third gate electrode insulation layer 1263 is disposed between the second conductive layer 1252 and the second semiconductor layer 1242.

The third conductive layer 1253 is disposed on a side of the second conductive layer 1252 away from the substrate 111. The third conductive layer 1253 may include the source and drain of the low-temperature polysilicon transistor 1231, and the third conductive layer 1253 may include a connection electrode connected to the metal oxide active layer. A first interlayer insulation layer 1271 may be disposed between the third conductive layer 1253 and the second conductive layer 1252.

The driving circuit layer 120 may further include a second interlayer dielectric layer 1272. The second interlayer dielectric layer 1272 is disposed on a side of the first interlayer dielectric layer 1271 away from the substrate 111 and covers the third conductive layer 1253 to protect the third conductive layer 1253.

In some embodiments, any one of the first gate insulation layer 1261, the second gate insulation layer 1262, the third gate insulation layer 1263, the first interlayer dielectric layer 1271, and the second interlayer dielectric layer 1272 may include an inorganic insulating material.

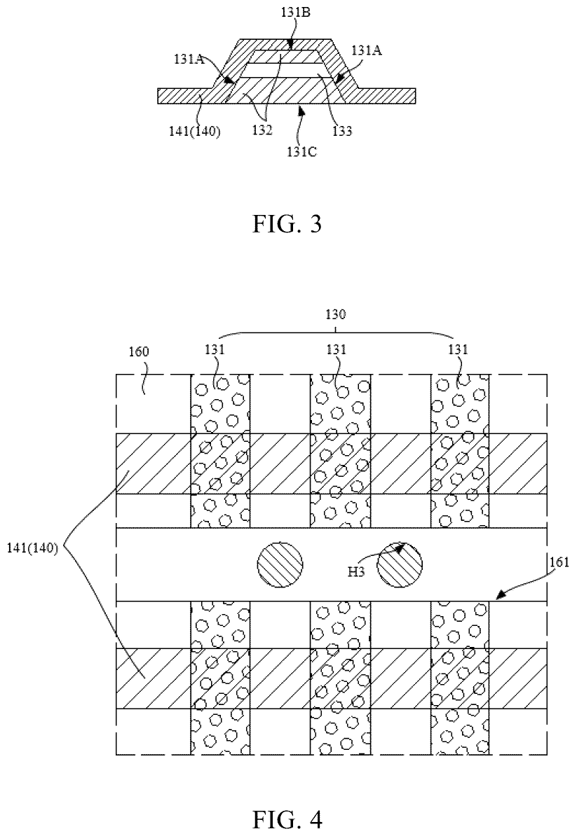

FIG. 3 is a schematic view of the local layout of an organic insulation layer, a light-shielding layer, a first common electrode layer, and a second passivation layer according to some embodiments of the present disclosure. FIG. 4 is a schematic cross-sectional view of the direct contact between a first common electrode layer and a light-shielding layer according to some embodiments of the present disclosure.

In some embodiments, as shown in FIGS. 1 and 2, the light-shielding layer 130 is disposed on a side of the driving circuit layer 120 away from the substrate 111 and includes a plurality of light-shielding lines 131. The plurality of light-shielding lines 131 overlap with at least some of the signal lines 121. In this way, the plurality of light-shielding lines 131 provide shading for at least part of the signal lines 121, which is beneficial to reducing the size of the organic light-shielding matrix 21 that also shields the signal lines 121, thereby enhancing the aperture ratio of the display panel 100.

In some embodiments, as shown in FIGS. 1 and 2, the plurality of light-shielding lines 131 overlap with the plurality of data lines 1211 respectively, ensuring that the plurality of light-shielding lines 131 block the plurality of data lines 1211. In some embodiments, the width of the light-shielding line 131 may be greater than or equal to the width of the data line 1211.

In some embodiments, the extending direction of the plurality of shielding lines 131 may be parallel to the extending direction of the plurality of data lines 1211.

In other embodiments, the plurality of light-shielding lines 131 may overlap with the plurality of scan lines to ensure that the plurality of light-shielding lines 131 block the plurality of scan lines.

As shown in FIG. 4, each light-shielding line 131 includes a metal light-shielding layer 132 disposed in the display region 100A to enhance the light-shielding performance of the layer 130. In some embodiments, as shown in FIG. 4, each light-shielding line 131 includes two metal light-shielding layers 132 and an insulating dielectric layer 133, and the insulating dielectric layer 133 is disposed between the two metal light-shielding layers 132 to enhance the light-shielding performance of the light-shielding line 131 and to reduce the reflectivity of the light-shielding layer 130 to light. In some other embodiments, each light-shielding line 131 may include a metal shading layer 132 and an insulating dielectric layer 133 arranged in a stacked manner.

In some embodiments, the thickness of the light-shielding layer 130 may ranges from 0.1 microns to 0.3 microns to ensure the light-shielding performance of the light-shielding layer 130 and reduce the reflectivity of the light-shielding layer 130.

In some embodiments, the metal light-shielding layer 132 may include at least one of molybdenum, aluminum, titanium, copper, and silver. In some embodiments, the metal light-shielding layer 132 may include Mo—Al—Mo, Ti—Al—Ti, Mo—Cu—Mo, Ti—Cu—Ti, Al—Mo, Al—Ti, Cu—Mo, or Cu—Ti or other laminated metal materials.

In some embodiments, the interlayer dielectric layer 133 may include inorganic insulating materials, which include but are not limited to at least one of silicon oxide, silicon nitride, and silicon oxynitride.

In some embodiments, as shown in FIG. 4, each light-shielding line 131 has two opposite first side surfaces 131A, a first top surface 131B and a first bottom surface 131C. The first top surface 131B is disposed on a side of the first bottom surface 131C facing away from the substrate 111. Both first side surfaces 131A are connected between the first top surface 131B and the first bottom surface 131C. The first common electrode layer 140 extends from the driving circuit layer 120 onto the first top surface 131B of the light-shielding line 131 via at least one first side surface 131A. In this way, part of the light-shielding layer 130 is disposed below the first common electrode layer 140, so that the first common electrode layer 140 is in direct contact with at least one first side surface 131A and the first top surface 131B of the light-shielding line 131, so as to realize direct contact between the common electrode layer 140 and the metal light-shielding layer 132, thereby addressing the problems of electrostatic damage and signal crosstalk caused by the metal light-shielding layer 132 being in a floating state.

It should be noted that in the related art, an insulation layer is provided between the first common electrode layer and the metal light-shielding layer, and the two are connected through a via hole in the insulation layer. Compared with the related art, in the embodiments of the present disclosure, the insulation layer between the first common electrode layer 140 and the metal light-shielding layer 132 is removed, so that the first common electrode layer 140 is in direct contact with both at least one first side surface 131A and the first top surface 131B of the light-shielding line 131, which may simplify the manufacturing process of the display panel 100.

In some embodiments, the angle between the first side surface 131A and the first bottom surface 131C may be greater than or equal to 30 degrees and less than or equal to 70 degrees. In this way, it is ensured that the inclination of the first side 131A is within an appropriate range, and the risk of breakage of the first common electrode layer 140 is reduced when extending along the first side 131A, while also addressing the problem of increased reflectivity of the light-shielding layer 130 caused by the inclination of the first side 131A being too small. Optionally, the angle between the first side surface 131A and the first bottom surface 131C may be greater than or equal to 35 degrees and less than or equal to 65 degrees.

The first common electrode layer 140 is used to transmit a common voltage. In some embodiments, as shown in FIGS. 1 and 2, the first common electrode layer 140 includes plurality of first common electrode lines 141 spaced apart from each other. The plurality of first common electrode lines 141 may be connected through a conductive connection structure of the non-display region 100B.

In some embodiments, in the extending direction of the first common electrode line 141, one first common electrode line 141 intersects with at least two light-shielding lines 131, that is, the extending direction of the first common electrode line 141 intersects with the extending direction of the light-shielding lines 131. In addition, the first common electrode line 141 is in direct contact with the first top surface 131B and the two first side surfaces 131A of each of the at least two light-shielding lines 131. In this way, one first common electrode line 141 may be in contact with the metal light-shielding layers 132 of at least two light-shielding lines 131, simplifying the connection process between the first common electrode line 141 and the at least two light-shielding lines 131.

In the case where each light-shielding line 131 includes two metal light-shielding layers 132 and an insulating dielectric layer 133, the first common electrode layer 140 may be in direct contact with the two metal light-shielding layers 132 via the first side surface 131A.

In some embodiments, the first common electrode layer 140 may include transparent conductive materials such as indium tin oxide.

In some embodiments, as shown in FIG. 1, the display panel 100 further includes a pixel electrode layer 150. At least part of the pixel electrode layer 150 is disposed on the side of the first common electrode layer 140 and the light-shielding layer 130 away from the substrate 111, and is electrically insulated from the first common electrode layer 140. The pixel electrode layer 150 is connected to the pixel driving circuit 122. The pixel electrode layer 150 overlaps at least part of the first common electrode layer 140 to form a first storage capacitor.

In some embodiments, as shown in FIGS. 1 and 3, the display panel 100 may further include an organic insulation layer 160, which is disposed between the light-shielding layer 130 and the driving circuit layer 120. The organic insulation layer 160 serves to planarize the driving circuit layer 120. The organic insulation layer 160 includes a plurality of through grooves 161 disposed in the display region 100A and penetrating the organic insulation layer 160. At least part of the pixel electrode layer 150 are disposed in the through grooves 161 to facilitate the connection between the pixel electrode layer 150 and the pixel driving circuit 122 in the driving circuit layer 120, and is also conducive to the display panel 100 in achieving high-resolution display.

In the related art, due to process limitations, the minimum size of via holes of the organic insulation layer is in the micron level, resulting in a large layout space occupied by via holes, which is not conducive to display panels in achieving high-resolution display. The embodiments of the present disclosure use the through grooves 161, whose formation process is simpler and whose size is not limited by the process. Additionally, it ensures a connection between the pixel electrode layer 150 and the pixel driving circuit 122.

In some embodiments, as shown in FIG. 3, the through grooves 161 do not overlap with the plurality of light-shielding lines 131, thereby reducing the risk of short circuit between the pixel electrode layer 150 and the first common electrode layer 140, caused by the contact between the plurality of light-shielding lines 131 and a part of the pixel electrode layer 150 disposed in the through grooves 161.

In some embodiments, the extension direction of the through groove 161 is parallel to the extension direction of the first common electrode line 141. The orthographic projection of the through groove 161 on the substrate 111 is disposed between two adjacent first common electrode lines 141. The gap between adjacent light-shielding lines 131 overlapped by one data line 1211 overlaps with the through groove 161, so that the light-shielding line 131 and the through groove 161 are staggered.

In some embodiments, the thickness of the organic insulation layer 160 is greater than or equal to 0.5 microns and less than or equal to 1 micron.

In some embodiments, as shown in FIG. 1, the display panel 100 further includes a plurality of light-transmitting conductive structures 180. The light-transmitting conductive structure 180 is connected to a part of the pixel electrode layer 150 disposed in the through groove 161 and the pixel driving circuit 122. Since the light-transmitting conductive structure 180 is light-transmitting, the aperture ratio of the display panel 100 is further enhanced. In the case where the pixel driving circuit 122 includes the metal oxide transistor 1221, the light-transmitting conductive structure 180 is connected to the metal oxide transistor 1221 and a part of the pixel electrode layer 150 disposed in the through groove 161.

In some embodiments, the light-transmitting conductive structure 180 may include transparent conductive materials such as indium tin oxide.

In some embodiments, as shown in FIG. 1, the pixel electrode layer 150 includes a first light-transmitting conductive layer 151 and a second light-transmitting conductive layer 152. At least part of the first light-transmitting conductive layer 151 are disposed in the through grooves 161. The second light-transmitting conductive layer 152 is disposed on a side of the first light-transmitting conductive layer 151 away from the substrate. In this way, the risk of connection failure between the pixel electrode layer 150 and the pixel driving circuits 122 is reduced, and it is beneficial to ensuring that the distance between the second light-transmitting conductive layer 152 and the second common electrode layer 193 below is relatively close, ensuring that the electric field generated by the voltage difference between the two may better drive the rotation of the liquid crystal molecules of the liquid crystal layer.

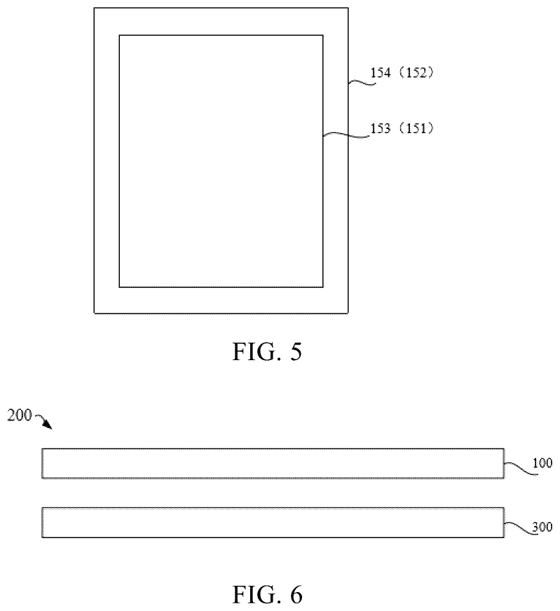

FIG. 5 is a schematic view of the partial layout of a pixel electrode layer according to some embodiments of the present disclosure.

As shown in FIG. 5, the first light-transmitting conductive layer 151 may include plurality of first pixel electrodes 153, and the second light-transmitting conductive layer 152 may include plurality of second pixel electrodes 154. A part of the plurality of first pixel electrodes 153 may be disposed in the through grooves 161. The plurality of first pixel electrodes 153 are respectively stacked with and connected to the plurality of second pixel electrodes 154 in a one-to-one manner.

In some embodiments, the orthogonal projection of the first pixel electrode 153 on the substrate 111 is disposed within the orthogonal projection of the second pixel electrode 154 on the substrate 111. In this way, the size of the second pixel electrode 154 is greater than the size of the first pixel electrode 153, and the cooperation between the second pixel electrodes 154 and the first common electrode layer 140 and the second common electrode layer 193 below may better drive the rotation of the liquid crystal molecules in the liquid crystal layer.

In some embodiments, both the first light-transmitting conductive layer 151 and the second light-transmitting conductive layer 152 include transparent conductive materials such as indium tin oxide.

In some embodiments, the display panel 100 further includes a filling material 182. The filling material 182 is filled in the through grooves 161, and part of the filling material 182 is disposed between the first light-transmitting conductive layer 151 and the second light-transmitting conductive layer 152. The filling material plays a flattening effect on the through groove 161 to ensure the flatness of the second light-transmitting conductive layer 152 and other structures around the through groove 161.

In some embodiments, the filling material 182 may include a light-transmitting organic insulating material to ensure that the filling material may better fill the through grooves 161.

In some embodiments, as shown in FIG. 1, the display panel 100 further includes a second common electrode layer 193, which is used to transmit the common voltage. The second common electrode layer 193 is disposed on a side of the pixel electrode layer 150 away from the substrate 111 and is electrically insulated from the pixel electrode layer 150. At least part of the second common electrode layer 193 overlaps with the pixel electrode layer 150 to form a second storage capacitor. The first storage capacitor cooperates with the second storage capacitor to improve the flicker and signal crosstalk of the display panel 100.

In some embodiments, the second common electrode layer 193 may include transparent conductive materials such as indium tin oxide. The second common electrode layer 193 may include a plurality of openings.

In some embodiments, as shown in FIG. 1, the display panel 100 further includes a first passivation layer 170, a second passivation layer 171, and a third passivation layer 172. The first passivation layer 170, the second passivation layer 171, and the third passivation layer 172 may each include an inorganic insulating material.

The organic insulation layer 160 is disposed between the first passivation layer 170 and the driving circuit layer 120. The first passivation layer 170 is disposed between the driving circuit layer 120 and the light-shielding layer 130, as well as disposed between the driving circuit layer 120 and the first common electrode layer 140. In addition, the first passivation layer 170 is in direct contact with the first common electrode layer 140 and the light-shielding layer 130.

The second passivation layer 171 is disposed between the first common electrode layer 140 and part of the pixel electrode layer 150, as well as disposed between the light-shielding layer 130 and part of the pixel electrode layer 150. In addition, the second passivation layer 171 is in direct contact with the light-shielding layer 130 and the first common electrode layer 140.

The third passivation layer 172 is disposed between the pixel electrode layer 150 and the second common electrode layer 193.

In some embodiments, as shown in FIG. 1, the driving circuit layer 120 further includes a signal transmission structure 181, and the signal transmission structure 181 is disposed in the non-display region 100B. The signal transmission structure 181 is used to transmit a common voltage. The signal transmission structure 181 may include at least one of a pad and a common electrode trace. In some embodiments, the third conductive layer 1253 includes the signal transmission structure 181.

In some embodiments, the organic insulation layer 160 further includes a through hole 162, and the through hole 162 is disposed in the non-display region 100B and penetrates the organic insulation layer 160. The through hole 162 and the through grooves 161 may be prepared using the same photomask, thereby reducing the manufacturing cost of the display panel 100.

In some embodiments, as shown in FIG. 1, the display panel 100 further includes a first connection hole H1. The first connection hole H1 is disposed in the through hole 162, penetrates a part of the first passivation layer 170 formed in the through hole 162 and a part of the second passivation layer 171 formed in the through hole 162, and extends into the driving circuit layer 120. In this way, the first connection hole H1 is sleeved in the through hole 162, and the first connection hole H1 and the through hole 162 may be formed step by step to reduce the manufacturing difficulty of the display panel 100.

In some embodiments, the driving circuit layer 120 may further include a third interlayer dielectric layer 1273. The third interlayer dielectric layer 1273 is disposed between the organic insulation layer 160 and the second interlayer dielectric layer 1272. The first connection hole H1 penetrates a part of the first passivation layer 170 disposed in the through hole 162 and a part of the second passivation layer 171 in the through hole 162, and extends into the third interlayer dielectric layer 1273.

The display panel 100 further includes a second connection hole H2. The second connection hole H2 is in communication with the first connection hole H1, and the second connection hole H2 penetrates a part of the third passivation layer 172 in the first connection hole H1, and extends into the driving circuit layer 120 to expose the signal transmission structure 181. A part of the second common electrode layer 193 is disposed in the first connection hole H1 and the second connection hole H2 and is in contact with the signal transmission structure 181. In this way, the second common electrode layer 193 is connected to the signal transmission structure 181 through the first connection hole H1 and the second connection hole H2. Moreover, the first connection hole H1 and the second connection hole H2 may be formed step by step to simplify the manufacturing process of the display panel 100.

In some embodiments, the second connection hole H2 penetrates a part of the third passivation layer 172 disposed in the first connection hole H1 and extends into the second interlayer dielectric layer 1272.

In some embodiments, the display panel 100 further includes a plurality of third connection holes H3. The third connection hole H3 is disposed in the through groove 161. The third connection hole H3 penetrates through a part of the first passivation layer 170 formed in the through groove 161 and the second passivation layer 171 formed in the through groove 161, and extends into the driving circuit layer 120, and a part of the pixel electrode layer 150 is disposed in the third connection hole H3. Thus, the pixel electrode layer 150 may be connected to the light-transmitting conductive structure 180 in the driving circuit layer 120 through the third connection hole H3. Furthermore, the third connection hole H3 is sleeved in the through groove 161, and the third connection hole H3 and the through groove 161 may be formed step by step to reduce the manufacturing difficulty of the display panel 100. Furthermore, since the third connection hole H3 and the first connection hole H1 both penetrate the first passivation layer 170 and the second passivation layer 171, and extend into the driving circuit layer 120, they may be manufactured using the same photomask, thereby reducing the manufacturing cost of the display panel 100.

In some embodiments, both the first connection hole H1 and the third connection hole H3 penetrate the first passivation layer 170 and the second passivation layer 171, and extend into the third interlayer dielectric layer 1273, ensuring both penetrating the same film layers.

In some embodiments, the display panel 100 further includes a fourth connection hole H4. The fourth connection hole H4 is disposed in the non-display region 100B, and the fourth connection hole H4 penetrates the third passivation layer 172 and the second passivation layer 171, and exposes the first common electrode layer 140. A part of the second common electrode layer 193 is disposed in the fourth connection hole H4 and is in contact with the first common electrode layer 140. Thus, the second common electrode layer 193 bridges the first common electrode layer 140 and the signal transmission structure 181, allowing the common voltage transmitted by the signal transmission structure 181 to be conveyed to the second common electrode layer 193. Furthermore, since both the fourth connection hole H4 and the second connection hole H2 penetrate the third passivation layer 172, they may be manufactured using the same photomask, thereby reducing the manufacturing cost of the display panel 100.

Based on the above, the through hole 162, the first connection hole H1, and the second connection hole H2 may all be manufactured using the same photomask, thereby reducing the manufacturing cost of the display panel 100.

In some embodiments, as shown in FIG. 1, the display panel 100 further includes a plurality of pad structures 191 and a plurality of spacers 192. The pad structures 191 are disposed in the display region 100A, and are on a side of the second common electrode layer 193 away from the substrate 111. The spacers 192 are disposed in the display region 100A and disposed on the pad structures 191. In this way, the pad structures 191 serve to raise the spacers 192, reducing the risk of the spacers 192 sliding to damage other film layers. Furthermore, the pad structures 191 are disposed on the second common electrode layer 193, the pixel electrode layer 150, and the first common electrode layer 140, reducing the risk of damage to other insulation layers caused by the pad structures 191 being disposed below the second common electrode layer 193, thereby reducing the risk of short circuits between different conductive layers due to damage to the insulation layers. Furthermore, the pad structures 191 are disposed on the second common electrode layer 193, allowing the pad structures 191 to be made thicker and larger to ensure better support for the spacers 192.

In some embodiments, the thickness of the pad structure 191 is greater than the thickness of the light-shielding layer 130, ensuring that the pad structure 191 has a larger thickness, which may provide a better raising effect for the spacer 192 and may further reduce the risk of the spacer 192 sliding to damage other film layers.

In some embodiments, the ratio of the thickness of the pad structure 191 to the thickness of the light-shielding layer 130 may be greater than 3 and less than or equal to 7. Thus, the thickness of the pad structure 191 is ensured to fall within an appropriate range, maintaining its raising function while reducing manufacturing difficulty. Optionally, the ratio of the thickness of the pad structure 191 to the thickness of the light-shielding layer 130 may be greater than 4 and less than or equal to 6.

In some embodiments, the pad structure 191 includes an organic support block to ensure that the pad structure 191 has sufficient thickness, while also guaranteeing a certain cushioning performance, thereby enhancing its deformation resistance. In some embodiments, the pad structure 191 may include an inorganic insulation layer.

In some embodiments, as shown in FIG. 1, the pad structure 191 includes a second bottom surface 191A, a second top surface 191B, and a second side surface 191C. The second top surface 191B is disposed on a side of the second bottom surface 191A away from the substrate 111. The second side surface 191C is connected between the second bottom surface 191A and the second top surface 191B. The included angle between the second side surface 191C and the second bottom surface 191A is greater than or equal to 30 degrees and less than or equal to 90 degrees. In this way, the second side surface 191C is ensured to have an appropriate slope, the second top surface 191B is ensured to provide a sufficiently large support area for the spacer 192, while addressing the problem of the second bottom surface 191A occupying too much space, which is not conducive to enhancing the aperture ratio.

In some embodiments, the included angle between the second side surface 191C and the second bottom surface 191A may be greater than or equal to the included angle between the first side surface 131A and the second bottom surface. This design makes the second side surface 191C of the pad structure 191 steeper, addressing the problem of the second bottom surface 191A occupying too much space, which is not conducive to enhancing the aperture ratio.

In some embodiments, as shown in FIG. 1, the display panel 100 further includes an organic light-shielding matrix 21, which overlaps with the light-shielding lines 131 and the signal lines 121 to provide shielding for the signal lines 121. In some embodiments, the organic light-shielding matrix 21 further covers the gaps between adjacent light-shielding lines 131 overlapping the data lines 1211.

In some embodiments, the organic light-shielding matrix 21 may be disposed on the substrate 111 and on a side of the light-shielding layer 130 away from the substrate 111. In other embodiments, as shown in FIG. 1, the organic light-shielding matrix 21 may be disposed on the counter substrate 20.

FIG. 6 is a schematic view of a structure of a display device according to some embodiments of the present disclosure. As shown in FIG. 6, the display device 200 includes the display panel 100 and a backlight module 300. The display panel 100 is disposed on the light exit side of the backlight module 300.

The description of the above embodiments is only for helping to understand the technical solutions of the present disclosure and the core ideas thereof. Ordinary skilled in the art should understand that it is still possible to modify the technical solutions recorded in the foregoing embodiments, and these modifications or replacements do not cause the essence of the corresponding technical solutions to deviate from the scope of the technical solutions of the embodiments of the present disclosure.

1. A display panel, wherein the display panel comprises a display region and comprises:
a substrate;
a driving circuit layer disposed on the substrate and comprising a plurality of signal lines disposed in the display region;
a light-shielding layer disposed on a side of the driving circuit layer away from the substrate and comprising a plurality of light-shielding lines, wherein the light-shielding lines overlap with at least ones of the signal lines, and each of the light-shielding lines comprises a metal light-shielding layer disposed in the display region;
a first common electrode layer stacked with the light-shielding layer in the display region and in direct contact with the metal light-shielding layer;
a pixel electrode layer, wherein at least a part of the pixel electrode layer is disposed on a side of the first common electrode layer away from the substrate and on a side of the light-shielding layer away from the substrate, and is electrically insulated from the first common electrode layer;
a second common electrode layer disposed on a side of the pixel electrode layer away from the substrate and electrically insulated from the pixel electrode layer;
a plurality of pad structures disposed in the display region and disposed on a side of the second common electrode layer away from the substrate; and
a plurality of spacers disposed in the display region and disposed on the pad structures.

2. The display panel of claim 1, wherein each of the light-shielding lines comprises two first side surfaces opposite to each other, a first top surface, and a first bottom surface, the first top surface being disposed on a side of the first bottom surface away from the substrate, and both of the first side surfaces being connected between the first top surface and the first bottom surface; and
wherein the first common electrode layer extends from the driving circuit layer via at least one of the first side surfaces onto the first top surface of one of the light-shielding lines.

3. The display panel of claim 2, wherein each of the pad structures comprises a second bottom surface, a second top surface, and a second side surface, the second top surface being disposed on a side of the second bottom surface away from the substrate, and the second side surface being connected between the second bottom surface and the second top surface; and
wherein an included angle between the second side surface and the second bottom surface is greater than or equal to included angles between the first bottom surface and the first side surfaces.

4. The display panel of claim 3, wherein the included angle between the second side surface and the second bottom surface is greater than or equal to 30 degrees and less than or equal to 90 degrees.

5. The display panel of claim 2, wherein the first common electrode layer comprises plurality of first common electrode lines, and in an extending direction of the first common electrode lines, one of the first common electrode lines intersects with at least two of the light-shielding lines and is in direct contact with the first top surface and the two first side surfaces of each of the at least two of the light-shielding lines.

6. The display panel of claim 1, further comprising:
an organic insulation layer disposed between the light-shielding layer and the driving circuit layer, wherein the organic insulation layer comprises a plurality of through grooves, the through grooves are disposed in the display region and penetrate the organic insulation layer; and at least a part of the pixel electrode layer is disposed in the through grooves, and the through grooves do not overlap with the plurality of light-shielding lines.

7. The display panel of claim 1, further comprising:
a first passivation layer disposed between the driving circuit layer and the light-shielding layer, as well as between the driving circuit layer and the first common electrode layer, wherein the first passivation layer is in direct contact with the first common electrode layer and the light-shielding layer;
a second passivation layer disposed between the first common electrode layer and a part of the pixel electrode layer, as well as between the light-shielding layer and a part of the pixel electrode layer, wherein the second passivation layer is in direct contact with the light-shielding layer and the first common electrode layer; and
a third passivation layer disposed between the pixel electrode layer and the second common electrode layer.

8. The display panel of claim 7, wherein the display panel further comprises a non-display region and comprises:
a signal transmission structure provided in the driving circuit layer and disposed in the non-display region;
an organic insulation layer disposed between the first passivation layer and the driving circuit layer, wherein the organic insulation layer is provided with a through hole, and the through hole is disposed in the non-display region and penetrates the organic insulation layer;
a first connection hole, wherein an orthographic projection of the first connection hole on the substrate is located within an orthographic projection of the through hole on the substrate, and the first connection hole penetrates the first passivation layer and the second passivation layer and extends into the driving circuit layer; and
a second connection hole in communication with the first connection hole in a region where the first connection hole is located, penetrating the third passivation layer and extending into the driving circuit layer to expose the signal transmission structure;
wherein a part of the second common electrode layer is disposed in the first connection hole and the second connection hole, and is in contact with the signal transmission structure.

9. The display panel of claim 8, wherein the organic insulation layer further comprises a plurality of through grooves, the through grooves being disposed in the display region and penetrating the organic insulation layer; and
wherein the display panel further comprises a plurality of third connection holes, an orthographic projection of each of the third connection holes on the substrate is located within an orthographic projection of one of the through grooves on the substrate, and the third connection holes penetrate the first passivation layer and the second passivation layer and extends into the driving circuit layer, and a part of the pixel electrode layer is disposed in the third connection holes.

10. The display panel of claim 8, further comprising:
a fourth connection hole disposed in the non-display region, penetrating the third passivation layer and the second passivation layer, and exposing the first common electrode layer;
wherein a part of the second common electrode layer is disposed in the fourth connection hole and is in contact with the first common electrode layer.

11. The display panel of claim 1, wherein a thickness of each of the pad structures is greater than a thickness of the light-shielding layer.

12. The display panel of claim 1, wherein each of the pad structures comprises an organic support block.

13. The display panel of claim 1, wherein each of the light-shielding lines comprises two metal light-shielding layers and an insulating dielectric layer, the insulating dielectric layer being disposed between the two metal light-shielding layers.

14. The display panel of claim 1, further comprising:
an organic light-shielding matrix overlapping with the light-shielding lines and the signal lines.

15. The display panel of claim 1, wherein the display panel further comprises a non-display region, and the driving circuit layer further comprises a low-temperature polycrystalline silicon transistor disposed in the non-display region.

16. The display panel of claim 1, wherein the driving circuit layer further comprises a metal oxide transistor disposed in the display region.

17. A display device, wherein the display device comprises a display panel, and the display panel comprises a display region and comprises:
a substrate;
a driving circuit layer disposed on the substrate and comprising a plurality of signal lines disposed in the display region;
a light-shielding layer disposed on a side of the driving circuit layer away from the substrate and comprising a plurality of light-shielding lines, wherein the light-shielding lines overlap with at least ones of the signal lines, and each of the light-shielding lines comprises a metal light-shielding layer disposed in the display region;
a first common electrode layer stacked with the light-shielding layer in the display region and in direct contact with the metal light-shielding layer;
a pixel electrode layer, wherein at least part of the pixel electrode layer is disposed on a side of the first common electrode layer away from the substrate and on a side of the light-shielding layer away from the substrate, and is electrically insulated from the first common electrode layer;
a second common electrode layer disposed on a side of the pixel electrode layer away from the substrate and electrically insulated from the pixel electrode layer;
a plurality of pad structures disposed in the display region and disposed on a side of the second common electrode layer away from the substrate; and
a plurality of spacers disposed in the display region and disposed on the pad structures.

18. The display device of claim 17, wherein each of the light-shielding lines comprises two first side surfaces opposite to each other, a first top surface, and a first bottom surface, the first top surface being disposed on a side of the first bottom surface away from the substrate, and both of the first side surfaces being connected between the first top surface and the first bottom surface; and
wherein the first common electrode layer extends from the driving circuit layer via at least one of the first side surfaces onto the first top surface of one of the light-shielding lines.

19. The display device of claim 18, wherein each of the pad structures comprises a second bottom surface, a second top surface, and a second side surface, the second top surface being disposed on a side of the second bottom surface away from the substrate, and the second side surface being connected between the second bottom surface and the second top surface; and
wherein an included angle between the second side surface and the second bottom surface is greater than or equal to included angles between the first bottom surface and the first side surfaces.

20. The display device of claim 18, wherein the first common electrode layer comprises plurality of first common electrode lines, and in an extending direction of the first common electrode lines, one of the first common electrode lines intersects with at least two of the light-shielding lines and is in direct contact with the first top surface and both the first side surfaces of each of the at least two of the light-shielding lines.
